(19) United States
(12) Patent Application Publication
(10) Pub. No.: US 2003/0069906 A1
(43) Pub. Date: Apr. 10, 2003

(54) Method and system for multi-page web applications with central control

(76) Inventors: Bruce William Cichowlas, Framingham, MA (US); Bill Hughes, Randolph, MA (US)

Correspondence Address: Peter M. Dichiara, Hale and Dorr LLP, 60 State Street, Boston, MA, 02109, US

(21) Appl. No.: 09/916,699

(22) Filed: Jul. 27, 2001

(51) Int. Cl. G06F 17/24

(52) U.S. Cl. 707/501.1; 707/513

(57) ABSTRACT

A method and system for multi-page web applications with central control are disclosed. A web application description is provided to a central controller. The web application description has at least one statement to cause the display of a web page. At least one web page description is provided having at least one link that points to the central controller and that identifies the web application description. The central controller responds to an initial invokation thereof, causing statements in the web application to be executed. Before execution of the at least one statement that causes the display of a web page, implicit state information about the web application is stored, including storing information identifying a statement to execute. Upon executing the at least one statement that causes the display of a web page, execution of the web application description terminates. A user invokes the link in the web page thereby re-invoking the central contoller, and the central controller responds to the re-invoking, by reading the stored implicit state information and beginning execution at the statement identified thereby.

### CROSS-REFERENCE TO RELATED APPLICATIONS

This application is related to the following applications, all of which are filed on the same date that this application is filed, all of which are assigned to the assignee of this application, and all of which are incorporated by reference in their entirety:

A Method, System, and Computer Program Product for Developing and Using Stateful Web Applications (U.S. Pat. Apl. Ser. No. not yet assigned).

### BACKGROUND OF THE INVENTION

1. Field of the Invention

The invention in general relates to web-based applications and, more specifically, to methods, systems, and computer program products for creating and using stateful web applications that execute in an infrastructure that terminates the execution of programs in response to certain events, such as responding to requests.

2. Description of Related Art

FIG. 1 illustrates typical components of an exemplary modem web infrastructure 100. A user operates a browser 102 at their personal computer or other web-enabled device or appliance. The browser 102 typically communicates with a HTTP server 104 according to the HyperText Transfer Protocol (HTTP) over an IP network. In addition to communication with the browser, the HTTP server 104 communicates with a web server that may include the depicted Java Servlet Engine 106. The web server extensions may invoke other web server extensions or other software logic, such as the Engine 106 invoking the depicted JSP Servlet 108 which in turn invokes Java Server pages 111, or the Servlet 109 invoking Java beans 110. Though depicted as single entities, in fact, the servers and engines may be composed of several networked machines with dispatching software at a front end to dispatch a request to one of the machines. Moreover, the servers and engines may be distributed across an IP network remotely with respect to one another and with respect to the browser 102.

A user typically causes a browser 102 to issue a request for a URL 112 to an HTTP server 104. The request typically identifies a desired web page or service, e.g., the Login.jsp page 111a, but may include headers and other parameter information. The HTTP server 104 analyzes the request's headers and URL and may handle the request 112 by dispatching a corresponding request 114 to a web server extension, such as the depicted Java Servlet Engine 106. The web server extension 106 can either dispatch a corresponding request 116 to another server extension to assist the extension 106, or it may respond 115 to the request 114. In the illustrated example, the extension 106 dispatches a corresponding request 116 to the depicted JSP Servlet 108, which then locates the login.jsp file 111a and responds 117 to the Java Servlet Engine 106. The Java Servlet Engine may then respond 115 to the HTTP Server 104, which then sends 113 the page to the browser 102 for display to the user.

Web components and infrastructure are often implemented to follow various models and standards, such as the Java 2 Enterprise Edition (J2EE) specification, among others. Often the standards promote functionality that facilitates scalability and reusability. For example, web tier components, e.g., servlets, are designed to be stateless, so that they can handle requests efficiently and quickly without placing many demands (e.g., consuming memory resources to save context) on the physical platform on which they execute. Consequently, typically a servlet is instantiated to handle a request dispatched to it, and it terminates once it responds. The stateless nature of web servers ensures that any HTTP request can be handled by any web server process, regardless of what machine on the network it runs upon.

Unfortunately, though these standards benefit scalability and reusability, they often make it difficult to design, implement, or maintain the underlying web applications. For example, server extensions are designed so that they terminate upon issuing a response, e.g., 115, 117. Thus, a given instance of such an extension cannot, by design, issue more than one response because the first response will cause termination of the execution. This behavior makes it difficult to design and implement applications that would require multiple sequences of input and output (and thus multiple responses to a given request) or that would utilize state from a prior request or from prior processing. Moreover, because of these and other restrictions often the code's expression is not intuitive or logical in relation to the manner in which the program will actually execute.

Consider the flow chart of FIG. 2 which depicts the underlying logic of an exemplary web application. A login page is displayed 201 to a user; the entered information is received and processed 202; and the processed information is validated 203. The logic loops 204 until a user logs in successfully. Once a user logs in successfully 205, his or her account information is retrieved 206 and displayed 207.

FIG. 3 illustrates an exemplary Java-like expression of the logic of FIG. 2. One might desire to implement such application logic as Login servlet 109. The program expression suggests that the authentication state is initialized to “not valid” 301. A program loop continues to present the user with the web page Login.jsp by using a method RunPage until the doLogin method authenticates the user 202, 203, 204. Once the user is authenticated, the method getAccount is called to retrieve the user's account information from a database and to assign the result to the S.AccountInfo object item 205. The R object is passed by the RunPage method to the web page MyAccountjsp, which displays the data as formatted account information to the user 206.

Though the expression of FIG. 3 is an intuitive expression of the logic of FIG. 2, unfortunately, this code cannot be made to execute successfully as a single servlet on modem web infrastructures, such as those following J2EE and depicted in FIG. 1. Specifically, once the statement RunPage at line 303 executes, the servlet having this logic must terminate because the response will not be sent to the user until the servlet terminates, returning the response. The application logic will never get the opportunity to store a TRUE value for the variable Valid, will never break the control loop, and will never run getAccount 305 or display the MyAccount page 306. Thus, even though this application had only two high level states—(1) get and authenticate login information from a user and (2) display the account page for that user—it could not be expressed easily with program code modeling the business logic as a single servlet.

Instead a program like that shown in FIG. 4 would need to be written. The LoginEvent servlet 109 is invoked 401 with the Q.Username and Q.Password authentication information passed from the user as parameters. The servlet 109 calls 401 the doLogin method 110a to authenticate the user. If the authentication fails 402, the Login.jsp page is displayed 403 to the user. If the authentication is successful, the servlet 109 invokes 404 the getAccount method 110b to retrieve the user's account information to display 405 back to the user. In this example, the DispatchPage or RunPage statement terminate the servlet 109. Thus, the servlet instantiates with each login attempt and terminates each time the parameters are not valid, by displaying the Login.jsp page 111a. Notice that the servlet logic has no clear expression of looping, even though the execution of the application in fact includes looping, see FIG. 2 or 3. Instead the apparent looping is actually accomplished through re-invocations of the servlet. This lack of correspondence between program expression and execution often makes web applications difficult to design, develop, and maintain.

More complicated applications make the problem more acute. If an application developer wanted to extend the logic of FIG. 4 so that it counted the number of times a user attempted to login with incorrect parameters, e.g., to detect someone trying passwords at random, the application logic would need to count the number of invalid login attempts and preserve the count each time before the servlet terminated with the DispatchPage statement of line 403. This would require the programmer to include statements to count invalid entries, to explicitly persist the count (for example, via cookies or the like), and to restore the persisted count upon instantiation of the servlet 109.

Web applications that require multiple page displays in a user session either need to be implemented as multiple separate servlets (one per display) and have custom built “glue logic” to persist the necessary state across page displays, or they need to be constructed as phased applications where an application's phase value is persisted before the servlet terminate. Upon subsequent instantiation of the application servlet, i.e., after a page has been displayed, the phase needs to be restored from persisted state, and the servlet needs to case-branch (or the like) on the restored phase value. These “tricks” to implement stateful web applications complicate the code tremendously, making applications harder and more costly to design, implement, and maintain. For example, a significant effort is needed to make changes to the application, such as changing the flow of web pages, the flow of information from page to page, or the relationships among information that is shared across pages. The alternative is to establish rigid ground rules as to how pages should pass information to and from the persistent store and to implement complex application logic to know how this persistent information should be handled during different application states. Typically, this complexity results in more than half of the application development effort.

### SUMMARY

One aspect of the invention provides a method and system for multi-page web applications with central control. According to one aspect of the invention, a web application description is provided to a central controller. The web application description has at least one statement to cause the display of a web page. At least one web page description is provided having at least one link that points to the central controller and that identifies the web application description. The central controller responds to an initial invokation thereof, causing statements in the web application to be executed. Before execution of the at least one statement that causes the display of a web page, implicit state information about the web application is stored, including storing information identifying a statement to execute. Upon executing the at least one statement that causes the display of a web page, execution of the web application description terminates. A user invokes the link in the web page thereby re-invoking the central contoller, and the central controller responds to the re-invoking, by reading the stored implicit state information and beginning execution at the statement identified thereby.

### BRIEF DESCRIPTION OF THE DRAWINGS

In the Drawing,

FIG. 1 illustrates a prior art web application infrastructure;

FIG. 2 illustrates a flow chart illustrating the logic of an exemplary application;

FIG. 3 illustrates an exemplary program code expression for the logic of FIG. 2 which does not operate properly on the infrastructure of FIG. 1;

FIG. 4 illustrates an alternative program code expression for the logic of FIG. 2 which does operate properly on the infrastructure of FIG. 1;

FIGS. 5-7 illustrate the execution environment and state of certain embodiments of the invention, in which a program executor and/or a user program terminate (as a normal operation) in response to certain events, such as issuing a response to a request;

FIG. 8 illustrates infrastructure components of certain embodiments of the invention;

FIG. 9 illustrates an exemplary compiler, or translator, according to certain embodiments of the invention; and

FIGS. 10-11 illustrate an exemplary control servlet or program executor according to certain embodiments of the invention.

### DETAILED DESCRIPTION

Preferred embodiments of the invention provide a system, method and computer program product that allow developers to develop stateful web applications that execute on infrastructures that do not support stateful servlets or servlet environments. Consequently, though the infrastructure will normally (i.e., not the result of an error) terminate (not suspend) the execution of servlets in response to their responding to a request, a programmer may express the application logic in a high level language like Java and that application logic will be capable of issuing what appears to be several responses to a given request. Moreover, the application may share state received or processed in conjunction with issuing one response with another response or the processing thereof. And, the application may be expressed so that displays of web pages look like transfers of control akin to subroutine calls found in high level languages.

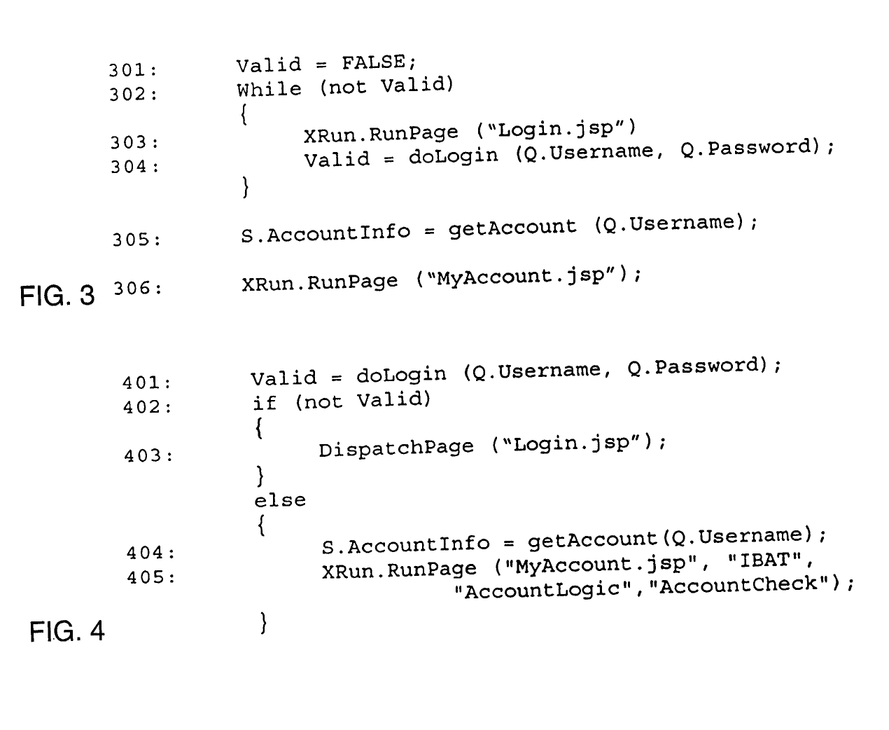

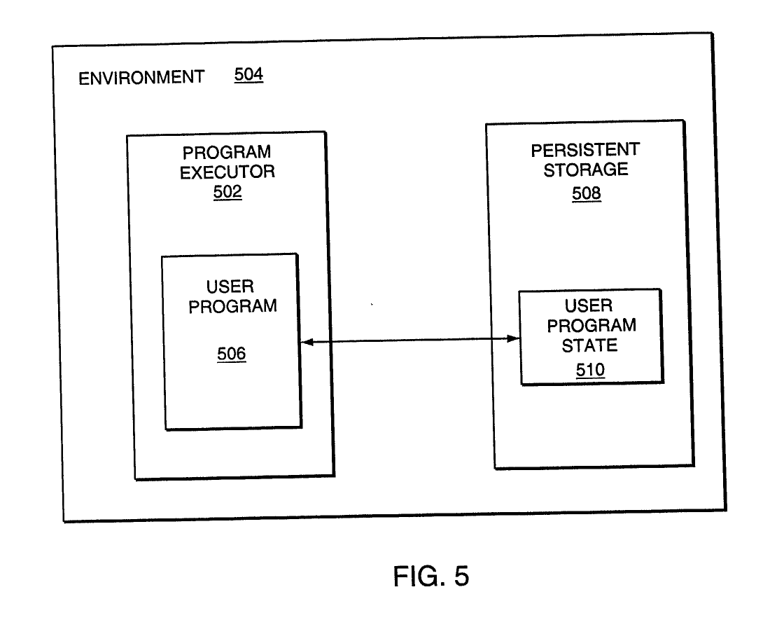

FIG. 5 is an architectural diagram illustrating the execution of stateful web applications under certain embodiments of the invention. A “program executor” 502 is loaded into a computer memory (part of the hardware execution environment) in one of the machines of a web server and executes within software environment 504, which defines the software context and environment-provided functionality. Under J2EE implementations, the program executor 502 could be a particular type of servlet, discussed below, and the environment 504 could be a servlet container or the like. The program executor 502 causes and controls the execution (or interpretation) of a “user program” 506. The user program 506 expresses the application logic of interest. For example, user program 506 could be a programmatic expression, or a translation of such, for the application logic of FIG. 3. The environment 504 provides a storage, such as a persistent storage 508, which may be used to store state 510 of the user program 506.

As will be explained below, certain embodiments of the invention cause state of program 506 to be stored in persistent storage 508 to facilitate the re-starting of the program 502 so that stateful programs 506 may be developed easily. Some embodiments achieve this through logic in the executor 502 that determines which state should be persisted to storage 510 and when, and other embodiments achieve this by automatically generating program instructions in the user program 506 (i.e., not generated by the application developer) that persist necessary state in storage 510. Under some embodiments, discussed in more detail below, executor 502 or program 506 keeps the state information 510 current at all times; that is, each time program state changes, storage 510 is updated accordingly. Alternatively, storage 510 might in fact be the only representation of the state of the program in whole or in part. Under other embodiments, executor 502 or program 506 determine whether the current operation of the user program 506 should cause termination and if so store away state on a “just-in-time” basis. Combinations of these techniques may also be employed.

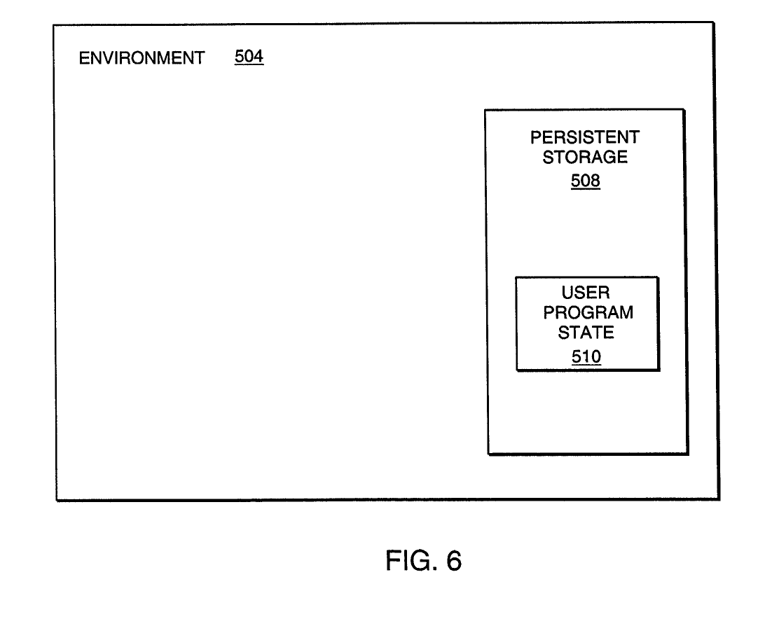

Program executor 502 and/or program 506 terminate in response to known operations or events when operating under J2EE infrastructures or under other environments 506 of interest. For example, in the J2EE context, servlets terminate after they respond to a request. FIG. 6 depicts the execution environment 504 after such an operation has been performed by program 506 shown in FIG. 5. Program 506 terminates because it has responded to a request, e.g., for a page, and program 502 has terminated because it has relayed the response of program 506. The user program and the program executor are gone from the environment 504, but the user program's necessary state remains in persistent storage 510 as a result of the persisting operations performed by the program executor and/or the user program.

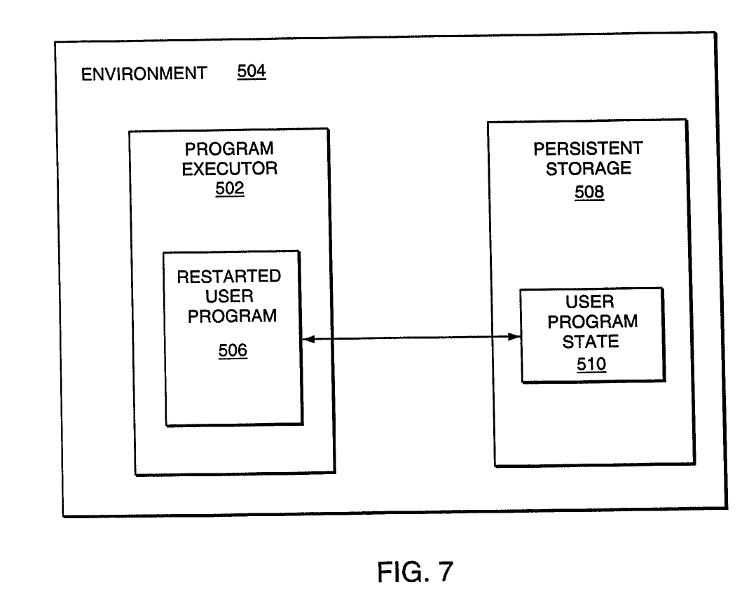

FIG. 7 illustrates the re-instantiation or subsequent invocation of the program executor 502 and user program 506. Logic in the program executor 502 and/or the user program 506 has caused the user program's persisted state 510 to be restored. This includes implicit state in the program expression as well as explicit state. Implicit state would include state information indicating where in the program 506 the program previously terminated. In this way, the user program 506 restarts execution at the point at which it was previously terminated and not at the initial program statements of the program's description. The execution state has effectively been reconstructed as it would have been if the previous action had not caused termination. Explicit application state would include program variables and the like, e.g., Valid in the code of FIG. 3.

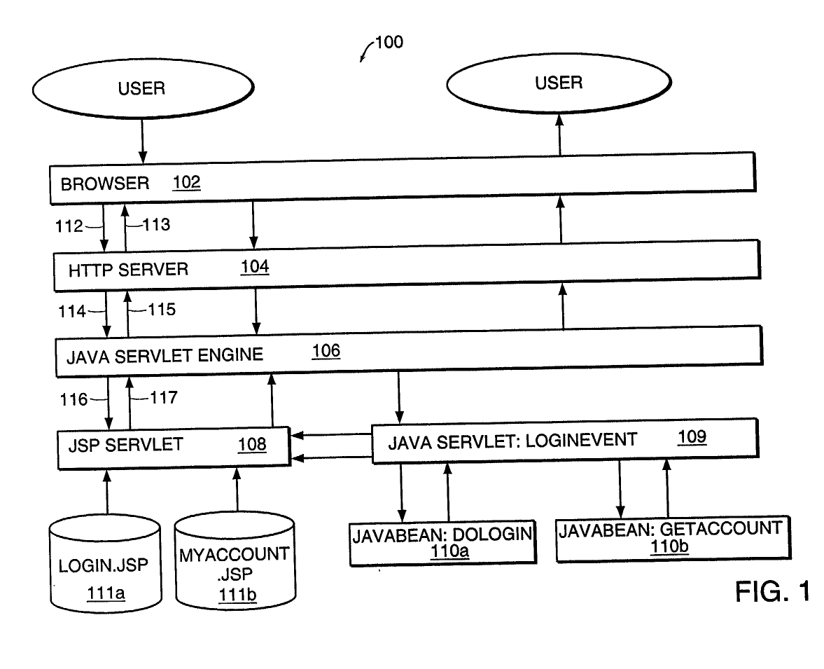

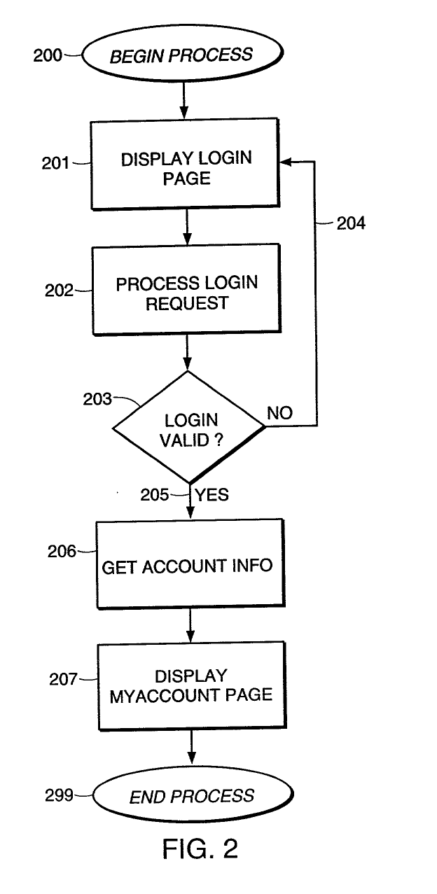

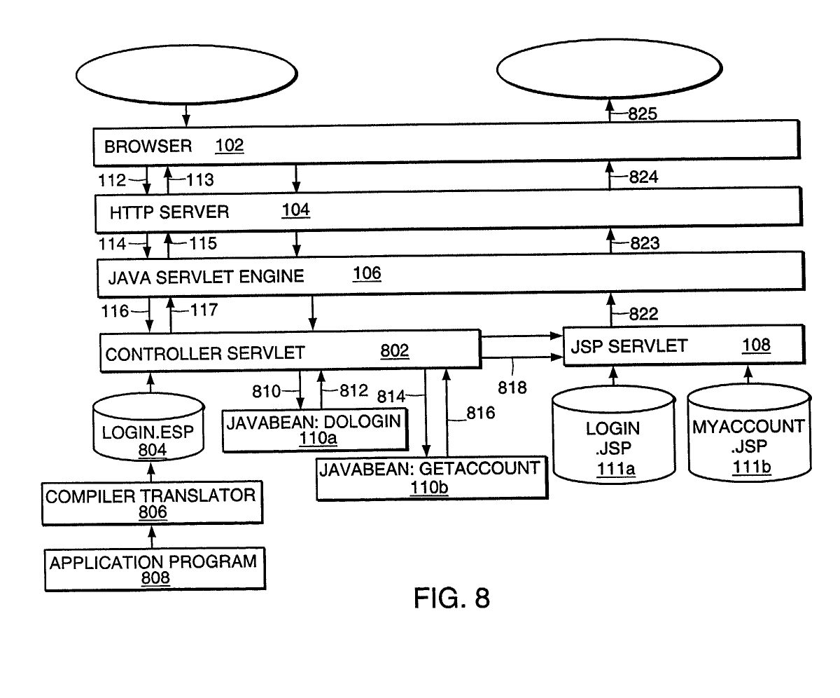

FIG. 8 shows the web infrastructure components of certain embodiments of the invention. Among other things, the embodiment of FIG. 8 supports the J2EE model of operation, including the termination of servlets when they respond to requests. The browser 102, HTTP Server 104, Java Servlet Engine 106, JSP Servlet 108, beans 110a and 110b, and Java server pages (JSPs) 111a and 111b are identical to those described in the background section. The controller servlet 802 is new as are the compiled program 804, the compiler/translator 806, and the original application program expression 808. Moreover, as will be explained below, some of the interactions among components differ from that described in connection with FIG. 1.

Under the illustrated embodiment of FIG. 8, the original application program expression 808 is a high level language expression of the desired web application program. The expression may be in a Java-like language or in other languages or derivatives. The expression 808 is not limited to the underlying functionality of the infrastructure and thus may include code suggesting the looping nature of actual execution, or it may suggest a sequence of multiple displays of pages to the user within an application session.

The program expression 808 may be written to suggest an application “session” that involves multiple page displays to a user—first displaying page A, then page B—even though the conventional infrastructure components and environment do not support such sessions. Moreover, as will be explained below, the displaying pages may be expressed to suggest transfers of control to and from the page in a manner equivalent to subroutine calls, as opposed to being expressed as execution-terminating events. In addition, the expression may be written to suggest that explicit state (such as application variables) or implicit state (such as an indication of successful execution or an indication of which instruction was last executed) is preserved from statement to statement, even though the servlet executing the expression may terminate many times during the course of the application session as a consequence of normal environment operations. Indeed, the servlet may even be re-instantiated on different machines in the web tier during the application session if this is supported by the containing environment. The controller servlet 802 in conjunction with the program 804 provides a virtual application session that supports the above functionality.

The operation of the system of FIG. 8 in part mirrors the operation of the system of FIG. 1. To make the description of the system clearer, assume that the original program expression 808 is the login application of FIG. 3. This expression 808 is compiled by compiler 806—in advance or perhaps “just in time”—to form program 804 Login.esp.

Using the embodiment of FIG. 8, a user would invoke the login application by causing a browser request having a URL to the login program 804. The browser 102 sends a GET login.esp request 112 to the HTTP Server 104, which dispatches a corresponding request 114 to the Java Servlet Engine 106, which in turn dispatches a request 116 to the controller servlet 802. The controller servlet reads the compiled execution program Login.esp 804, which dictates all of the process steps from this point forth. The controller servlet initializes its program environment (described later) and is ready to execute.

The program 804 initializes a local version of flag Valid indicating that authentication has not yet been validated, corresponding to the statement of line 301 in FIG. 3. Next, the program 804 begins a loop that terminates once authentication has occurred, following the logic of FIG. 3. The loop has two parts: first prompt the user for authentication information by presenting 303 the user with the login.jsp page 111a; second, get the authentication from the user's response 304. The login page 111a is retrieved via the JSP Servlet 108 and displayed to the user. This causes the termination of the instance of the controller servlet 802. Once the login page 11 la has been displayed, the user's response 112 (subsequent instance to opening the program by clicking on a submit button or the like) arrives at the HTTP Server 104 as a “get” request for the same Login.esp program 804 that the user has previously requested:

GET Login.esp?Username=<name>&Password=<pw>

This subsequent request creates a second instance (or re-instantiation) of the controller servlet 802. (In this example there are additional parameters attached to the request, but these merely pass information and do not directly influence the program flow.)

A request arrives at the new instance of the controller servlet 802 via a dispatch from the HTTP Server 104 through the Java Servlet Engine 106. This instance 802 initializes itself by locating and loading the persistent program environment, which restores the entire program environment, including a program pointer (more below), which tells the environment the next instruction in program 804 to execute. The request parameters, i.e., username and password, are made available to the application program by the controller servlet 804 through what appears to the programmer as Java object ‘Q’ available to the execution program Login.esp. The session object Q includes the username (Q.Username) and password (Q.password) items. When the program accesses object ‘Q’, corresponding changes are made in what is called a “request object” in the J2EE/JSP environment. The programmer is also given direct access to other J2EE/JSP objects, such as the session object through a similar mechanism. This capability is provided to the programmer in addition to the capability of having local variables, such as Valid in the example. Since the login page has been displayed, the subsequent instantiation of the controller servlet 802 should be restored with a program pointer value pointing to the next execution statement, i.e., a compiled form of line 304. Thus the second instantiation of controller servlet 802 should call 810 the method doLogin, implemented as bean 110a, with the authentication parameters. The doLogin method should return 812 a boolean value indicating whether the authentication information is valid. The flag Valid in the program 804 is set accordingly and may be persisted at this point or later in the execution. The loop of FIG. 3 continues until the user provides valid authentication information.

Once the user is authenticated, the loop is bypassed and the user's account information is requested 305. The controller servlet 802, operating under the direction of program 804, thus calls 814 the getAccount method of bean 110b and the resulting account information is returned 816 and assigned to the object S.AccountInfo in program 804 (see 305 of FIG. 3). Similar to “Q” used above, object ‘S’ may be implemented in the Java-like embodiment to result in storing to and accessing the J2EE/JSP session object. Since the account information is stored in a session object, the environment will be responsible for its persistence. However, a local variable could have been used in which case servlet 802 would have persisted it, storing or copying it to persistent storage either immediately or just before the next operation that might cause termination of the servlet. The program 804 then requests the display of the MyAccount.jsp page 11b to the user, which displays the formatted account information made available by session variable S.AccountInfo. The RunPage command 306 formats the request 818 to the JSP Servlet 108:

GET MyAccountjsp

In this embodiment, “RunPage” is a special function, directly implemented by servlet 802, which causes the specified page to be executed in a loop one or more times, or possibly not at all. Here is the pertinent line from the program in FIG. 4:

RunPage(“MyAccountjsp”, “IBAT”, “AccountLogic”, “AccountCheck”);

RunPage is representative of how embodiments of the invention allow JSP and other web pages and resources to be accessed modularly, for instance, in a means similar to subroutines. The four parameters are:

“MyAccount.jsp”- - - A partial or full URL to the page to be displayed or resource to be accessed.

“IBAT”- - - This stands for Initial/Before/After/Terminate and this parameter will be referred to here as the IBAT string. If this parameter is supplied, the following two parameters supply the name of a Java Bean and the name of a method within that bean. The properties which this method must meet are further specified below. If “I” appears in the IBAT string, then the supplied method will be called at the start of RunPage processing. If “T” appears in the IBAT string, then the supplied method will be called at the end of RunPage processing. If “B” appears in the IBAT string, the applied method will be called immediately before each time the specified URL (in this case “MyAccountjsp”) is displayed. If “A” appears in the IBAT string, it will appear to be called just after each time the specified URL is displayed. However, since displaying the URL will terminate servlet 802, it won't actually be called until the servlet has been reinvoked, probably from a user response to the previously displayed page. But because of how the implementation of servlet 802 makes these interruptions transparent to the programmer, he or she sees the “B”-before and “A”-after situations as quite symmetric.

“AccountLogic” and “AccountMethod” are the respective names of a java object and method that accepts an integer for an argument and also returns an integer, similar to:

int AccountMethod(int ibat) {

}

(Note that the mapping of the string “AccountLogic” to an actual Java Object could be handled in a number of ways. In the preferred embodiment, the contents of the string are the local variable name that references the object.)

The integer parameter “ibat” has a value which corresponds to the reason the method is being invoked. The preferred embodiment uses a simple index, i.e. 0 for initial, 1 for before, 2 for after, 3 for terminate.

The function must also return a value. In the preferred embodiment these are interpreted as follows:

1—fatal error. This will cause servlet 802 to terminate the user program as soon as possible, finishing by displaying the “final page” to the user.

0—OK. Proceed normally.

2—Cause the page to be displayed, possibly for an additional time. This code is only valid if the method was called for “before” or “after” processing.

To clarify, if the method is called for “before” processing and it returns a zero, the method will be called for terminate processing (3) next, if it requested this call in the IBAT string. In this case, the page will not be displayed any more by this invocation.

However, if the method was called for “before” processing and returns a two, the page will be displayed next (which actually terminates the servlet, but it doesn't seem this way to the programmer for reasons previously explained). Next, if there was no “after” processing requested, the “before” processing will happen again as described above. (A loop will result until the method stops returning a two.) If “after” processing is specified, the method will be called again, this time with an argument of 2 for after. If it returns zero, processing will continue with the method being called for terminate processing, if that was requested in the “IBAT” string, and then this invocation of RunPage will terminate. If a two was returned, and “before” processing has been requested, it will happen again next and its result heeded. Otherwise, the page will be displayed again and logically afterwards, our method will be called for “after” processing again. This will loop as long as it returns a two.

Once the end-of-file marker is reached for the program Login.esp, the instance of the controller servlet 802 terminates, and any persistence information regarding the program environment is removed, so that future requests by the user's browser 102 for the Login.esp program 804 will begin execution from the start of that program.

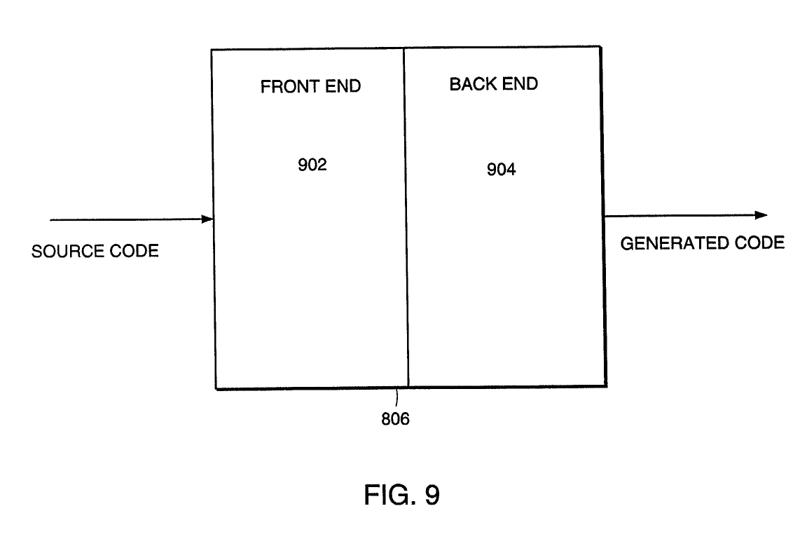

FIG. 9 illustrates an exemplary compiler/translator 806. The compiler 806 has a front end 902 and back end 904. The front end 902 uses parsing and other techniques to accept a particular source language to check that the expression 808 satisfies language rules, among other things. Under certain embodiments, the programming language of the source expression 808 is equivalent or similar to Java (and may for example constitute a subset of Java). The back end 904 responds to the front end and produces code which might directly executable by a computer or which might be interpretable by a computer. Under certain embodiments of the invention, the generated code output is an intermediate language implemented in XML.

The fragment below is an exemplary source expression 808.

#import esp.*;
public class Simple {

public static void main(String s[]){

esp.showPage(“PageA.html”);
esp.showPage(“PageB.html”);

}

}

The compiler 806 would generate from the above fragment a compiled program 804 like the one below:

<?xml version=“1.0” encoding=“UTF-8”?>
<Esp>

<proc name=“main”>

<seq>

<pageJSP page=“PageA.html”/>
<pageJSP page=“PageB.html”/>

</seq>

</proc>

</Esp>

In this example, the “esp” tags are used to delimit the application program and to identify that this program 804 is of a particular type. The “seq” tag delimits a structured programming “sequence” control structure. The “proc” tag delimits a procedure and allows procedures to be named. In this example, the procedure is “main” and the logic of the procedure is the delimited sequence, shown above. The “pageJSP” tags are used to delimit “calls” to html pages or the like. They are an example of a “servlet terminating statement;” that is, a statement which is known to cause the termination of a servlet executing such a statement, but not necessarily terminate the application session of which the servlet execution is a part. Preferred embodiments of the invention support other structured programming constructs commonly found in the art, such as control looping structures (if, do while, while, case, etc.).

In conjunction with the above, the pages PageA.html and PageB.html are programmed a certain way. In particular, the desired appearance of the application session would present page A, which in turn would include a link which when activated would cause the presentation of PageB. However in this embodiment, the link does not specify PageB (as would be the conventional case). Instead, the link specifies the compiled program 804. However, since J2EE/JSP servlets can be programmed to pass on these links to a particular servlet based on their apparent URL and/or file extension, a reference to the same page is not an essential part. Since the response can be reprogrammed in this fashion and/or the displayed page could have its link URL's edited “on the fly” before being displayed, legacy pages could be supported in many cases without requiring special editing for use with this invention.) For example, the page might look like the following:

<HTML>
<BODY BGCOLOR=‘ccddee’>
<CENTER>
<P><P><P>
<H1>This is Page A .</H1>
<P><P><P>
<FORM action=“/esp/servlet/simple.esp” method=post id=form1
name=form1 target=_top>
<INPUT type=“submit” value=“Submit” id=submit1 name=submit1
align=bottom>
</FORM>
</CENTER>
</BODY>
</HTML>

Thus, as procedure main of program 804 is executed by the control servlet 802, eventually the program statement for PageA is executed which causes page A to be displayed and causes the control servlet to terminate. However, as will be explained below, before termination, the control servlet is able to persist explicit and implicit application or session state.

If the user clicks on the link in PageA, the compiled program 804 is specified in a URL. This will effectively return control to a re-instantiated, restored control servlet 802. More specifically, the control servlet re-instantiates, as described above, and begins execution where it previously terminated by “jumping” to the portion of the program 804 pointed to by the program pointer 804. This will cause the execution to begin at the statement for PageB. Page B is programmed analogously to “return” control to the compiled program 804.

Page B, for example, might contain the following:

<HTML>
<BODY BGCOLOR=‘eeddcc’>
<CENTER>
<P><P><P>
<H1>This is Page B .</H1>
<P><P><P>
<FORM action=“/esp/servlet/simple.esp” method=post id=form1
name=form1 target=_top>
<INPUT type=“submit” value=“Submit” id=submit1 name=submit1
align=bottom>
</FORM>
</CENTER>
</BODY>
</HTML>

This simple program 804 does not use any local variables, but if there were any, they would be persisted and preserved so they could be restored when the control servlet re-instantiates. In a preferred embodiment, the user program 804 may access variables in the server request object and session object, as well as other global objects that might be provided by the environment, allowing the program to share web data with pages and servlets of all types. In a preferred embodiment, variables referring to the session object start with “S” and request object variables (parameters) start with “Q.” In the embodiments that support a Java-like language, a user program declares its intention to use these objects via declarations like the following:

#import S.*;
and
#import Q.*;

For instance, assume Page A is to put a man or woman's last name in a variable (parameter) named “LastName” and assume one wants to create a program to prepare a salutation to be used by Page B and pass it as variable (parameter) “Salutation.”Furthermore, assume Page A also produces a variable (parameter) named “Gender” that contains either “man” or “woman.” Perhaps there are two variants of PageB depending on the gender involved. This can be accomplished using preferred embodiments of the invention from a single program description 808, such as the one below, which will be compiled similarly to that described above:

#import esp.*;
#import Q.*;
public class Simple {

public static void main(String s[]){

esp.showPage(“PageA.html”);
if (Q.Gender == “man”)
{

Q.Salutation = “Dear Mr. “+ Q.LastName +“,”;
esp.showPage(“PageBMale.html”);

}
else

{

Q.Salutation =“Dear Ms. “+ Q.LastName +“,”;
esp.showPage(“PageBFemale.html”);

}

}

}

Although the arguments to esp.showPage are character constants in these examples, any expression could be used. In particular, the URL might correspond to a temporary file created dynamically by the application just for the occasion. This ability, combined with the capability of recapturing execution after page display, leads to the capability to implement simple and elaborate libraries of methods (functions) For instance, it becomes possible to implement a close equivalent of the Microsoft Windows MessageBox function (which is a handy way to offer the user simple choices and confirmation options without writing more than a single line of code). In fact, it is possible for the resulting pages, through the means of style libraries and other methods, to inherit the “look and feel” of the rest of the application, thereby blending in seamlessly, even though they were written with only a few seconds of effort. These methods and libraries can also be used as a means for users to exchange processing methods they have written.

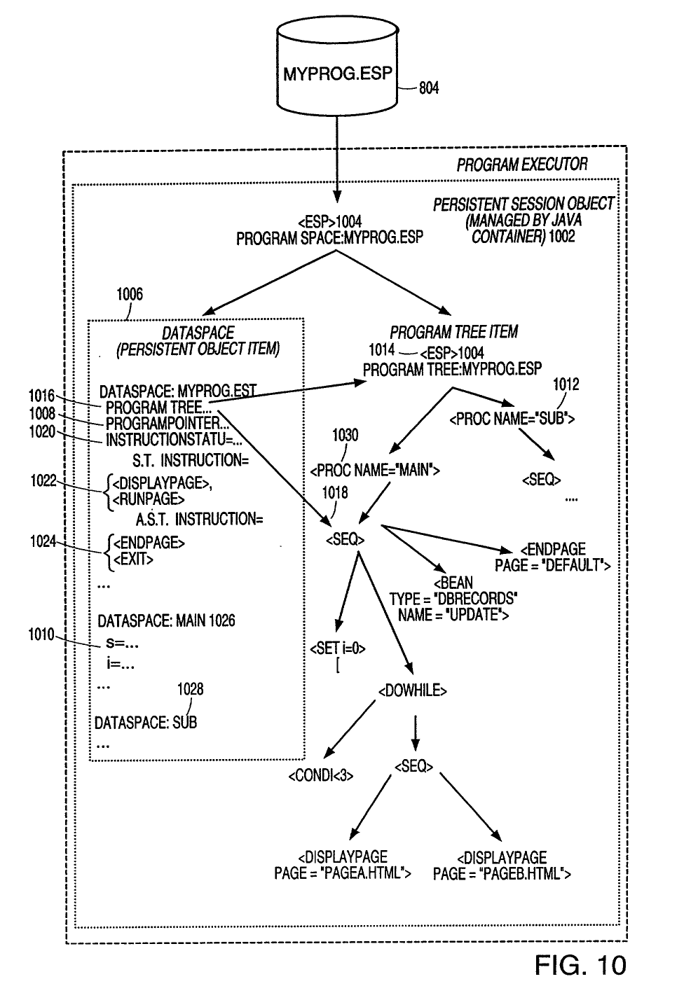

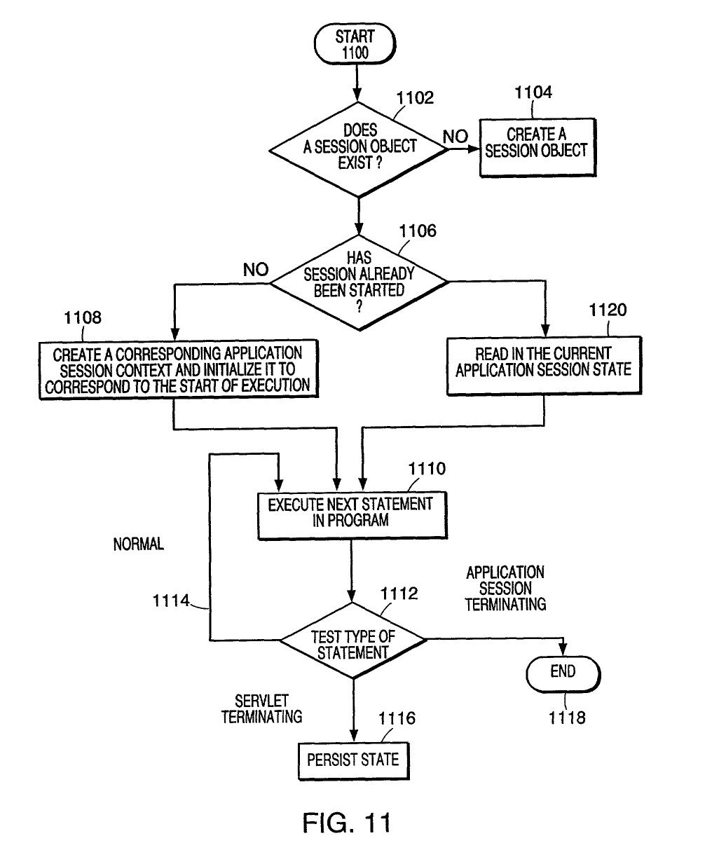

FIGS. 10 and 11 illustrate the logic of an exemplary embodiment of control servlet 802. The core activities of the control servlet 802 are (a) setting up a program space for the program 804 and (b) executing the program 804. To make the description more concrete, assume that the program 808 is as follows and that it is called

“Myprog.esp”:

#import esp.*;
public class Simple {

public static void main(String s[]){

int i;
i = 0;
while (i < 3) {

esp.showPage(“PageA.html”);
esp.showPage(“PageB.html”);

}
dbrecords.update();

}
public void sub() { . . .
}

}

Further assume that this program has been compiled or translated to form the following program 804 which is executed by servlet 802:

<?xml version=“1.0” encoding=“UTF-8”?>
<Esp>

<proc name=“main”>

<seq>

<set “i=0”>
<dowhile cond= “i<3”>

<seq>

<displayPage page=“PageA.html”/>
<displayPage page=“PageB.html”/>

</seq>

</dowhile>
<bean

type=”com.espressiv.j2ee.dbrecords”
name=”update”/>

</seq>

</proc>

</Esp>

Upon being instantiated 1100, the control servlet 802 first checks 1102 whether a corresponding session object exists. The session object is used to persist various forms of explicit and implicit application state, described below, for the application session. If no session object exists, one is created 1104 and named appropriately so that it may be subsequently identified.

When the control servlet is instantiated with a parameter identifying the above program 804, the control servlet 802 recognizes the program Myprog.esp as the program to be executed. The control servlet 802 checks 1106 to see whether an instance of Myprog.esp is currently being executed for the user by checking whether a persistent session object 1002 exists that contains a program space 1004 by that name. Under certain embodiments, the persistent session object 1004 is managed by a conventional Java container within the infrastructure.

If no program space is found to exist by that name, the control servlet 802 parses the XML program 804 Myprog.esp program into two spaces to help define 1108 an application session context: (1) a program tree 1004 for the program logic and (2) a dataspace 1006 for implicit and explicit application state. Implicit state would include a program pointer 1008 and the like used to manage execution of the program 804. Explicit state would include the various variables 1010 and the like explicitly expressed in the program 804.

The program tree 1004 is parsed according to known language compiler methods to create a description 1012 of the program 804. For example, the program tree for the above example starts with a node 1014 corresponding to an <esp> tag, signifying the beginning of the program 804 description. The remaining nodes and structure mirror the structure of the program 804 in accordance with known compilation techniques. This representation may likewise be traversed and accessed according to known techniques.

The dataspace 1006 includes a portion for reserved variables related to the entire program tree. The reserved variables are an example of implicit state. They include state such as a pointer 1016 to the program tree 1004, a program pointer 1008 that points to the next statement 1018 to be executed, an instruction status 1020 which indicates the status of a just executed instruction and which may helps in the processing of subsequent instructions. The servlet 802 may contain a list 1022 of servlet terminating (S.T.) instructions which identify any instructions that are expected to terminate the instance of the servlet, and a list 1024 of application session terminating (A.S.T.) instructions which identify any instructions that the control servlet expects to terminate the application session itself. If the first list has not been implemented, the servlet 802 will assume, possibly with some loss of efficiency, the servlet termination may happen at any time. In this case it would be sure to have stored enough information away at any point to reconstruct and resume execution at the next logical instruction. Notice that the “next” statement to be executed need not necessarily be the next statement sequentially listed in the program 808 or 804. Instead, “next” can be determined based on the tree's control structure iteration technique employed.

The dataspace 1006 also includes space for the various explicit variables, and these are organized according to program scope. For example, there is subspace 1026 for variables in the scope of the main procedure “main.” Other procedures (subroutines) are also read into the program tree and are available to other procedures based on the scope of those procedures. Besides having their logic represented in the program tree 1004 with the appropriate level of nesting, the variables have a corresponding subspace 1028 in the dataspace 1006.

Once the program space is established, certain embodiment start execution at a predefined procedure called “main” 1026. To this end, the control servlet 802 causes the program pointer 1008 to be initialized to point to the start of the main program 1030.

Execution begins 1110. The control servlet 802 interprets the instructions that should be executed as pointed to be program pointer 1008. It uses the dataspace 1006 similar to how a typical symbol table is used by typical program execution environment. As each statement is executed, the program pointer is updated to point to the next instruction in accordance with whatever tree iteration algorithm is employed.

In interpreting or executing an instruction, certain embodiments save into the session object 1002 (reserved for this program) line and offset information about the next instruction to be executed from program 804. If a method is invoked, the control servlet 802 creates a new context in the program space as needed so that return values for the program pointer may be persisted as well (in these instances, “next” instruction is determined dynamically and not by analysis of the program tree). If the instruction is a “return” instruction, the last created context is used to provide a return program pointer value to point to the next instruction.

The control servlet 802 also tests 1112 the program statement to determine its type. Under certain embodiments, the statement may be a normal statement, a servlet terminating statement, or an application session terminating statement. List 1022 and 1024 or their logical equivalent are used to do this, if they exist. Otherwise, as mentioned above, the servlet must assume that any statement whose type cannot be ascertained might be a servlet terminating statement.

Normal statements will cause the control servlet to loop back 1114 and continue the execution of the program 804.

If the statement is an servlet terminating statement, the particular instance of the control servlet will terminate upon execution of the statement and thus all state information is persisted 1116 to the session object 1002 that hasn't already been accurately stored there. This is done so that state may be subsequently reinstated. Once the state is persisted, the statement is executed which should terminate the instance of the servlet 802. Under certain embodiments, the program space is updated in real-time by using the persistent session object as the program space itself and by storing any other implicit state information there. This allows the Java container to manage persistence instead of having the control servlet 802 do this activity. Under other embodiments, the program space can be stored more efficiently and then persisted based on specific events, such as during instructions that involve interruptible instructions.

If the instruction is an application session terminating instruction, the program 804 has completed and the servlet 802 and application session will terminate gracefully. The program tree is reset or deleted, so that the next invocation of the program 804 results in the program being read if necessary and the program tree being run from the start with variables initialed to their appropriate fresh starting state.

In the case of servlet terminating instructions, a user is expected to click html pages or the like which will cause the re-instantiation of the control servlet 802 and the reading of the program 804. This should cause the control servlet 802 to follow the logic above, except that at activity 1106 the control servlet 802 should find that the appropriate session state has already been created. In this case, the control servlet 802 restores 1120 the state from the session object 1002 and restarts execution accodingly, i.e., moving to activity 1110 to execute the next logical instruction in program 804.

Under certain embodiments, the program 804 may still be resident in server memory when the servlet “returns” from a servlet terminating instruction. In these instances, the program need not be re-read into the execution environment.

Other Embodiments

Although the preferred embodiment shown will involve web applications with a supporting compiler and/or interpreter, the basic invention can be implemented in any environment supporting some manner of stored program execution and a means of persistent storage. A special compiler, or any compiler at all, is not necessarily required.

Under certain of the above embodiments, the control servlet detects terminating or interruptible instructions at run time and acts accordingly. For some embodiments, this functionality may be shifted to the compiler which could generate the necessary code for storing state and place it in alternative forms of program 804.

The above description primarily focuses on embodiments of the invention running in the context of a Java 2 Enterprise Edition (J2EE) implementation. The present invention, however, is not limited to any particular application or any particular environment. Instead, those skilled in the art will find that the system and methods of the present invention may be advantageously applied to a variety of system and applications software, including computing environments different from Java. Moreover, the present invention may be embodied on a variety of different kinds of servers architectures modeled on the web server, such as WML/WAP servers for wireless computing. Therefore, the description of the exemplary embodiments which follows is for purposes of illustration and not limitation.

For many environments, including the exemplary J2EE environment, the set of operations that may cause termination is known in advance, but if such a determination were not possible, this invention could still operate, perhaps with some loss of efficiency, by assuming that any operation might result in program termination.

Moreover, the above embodiments persist state which facilitates certain multi-machine server environments. Since the servlet may be re-instantiated on a different machine, the state is received from persistent storage. However, other mechanisms may be employed. For example, if the server uses a single machine the state may simply be stored in server memory. In multi-machine servers, the state may be saved in memory and shared with other machines as needed through memory sharing techniques, through message passing techniques, or through distributed object techniques.

Other implementations might not entirely reconstruct the state of a user program for storage efficiency or other reasons. For example, the author of a user program may be aware of which operations were terminating operations and which information would be lost and code the program in such a way that the lost information was not used further or was recovered in some other way.

It would be possible for the User Program to be written in something as “low-level” as machine code, provided the Program Executor controlling the execution were programmed to recognize the terminating instructions within.

Note that it is possible for the User Program described to implement calls to other languages implemented with other compilers and interpreters, provided that these calls do not contain any actions that would cause termination of the program. If it is necessary to call some function that would normally terminate the program, that function can be written in a language supporting the type of revivable execution described herein.

The choices of Java and XML as language models are arbitrary, but favor the above embodiments. Other embodiments would be to compile into a JSP Dispatch Servlet.

In other embodiments, the expression of application logic (e.g., FIG. 3) may be analyzed to determine data dependency in relation to expected terminating events to determine whether persistence of the variable or other state is needed, and if not persistence operations are avoided.

It is also possible to construct an additional program that could examine and interpret the state of a stored program for diagnosis purposes or to simulate execution, as a debugger might for instance. This ability might be used, for example, in a customer support system. A customer having problems could deliberately abandon their session and then a customer service representative could use an appropriately designed program to examine the state of execution of the customer and use this information to make recommendations or repairs.

Another situation in which this invention might make it advantageous for an end user to deliberately abandon execution of a program would be to then be able to continue the program later, logically from the previous position, at another computer, another time and/or geographic location. To facilitate this usage, security and identification routines might be used to positively confirm the identification of the user and their choice to continue with the abandoned session.

It will be further appreciated that the scope of the present invention is not limited to the above-described embodiments, but rather is defined by the appended claims; and that these claims will encompass modifications of and improvements to what has been described.

What is claimed is:

1. A method of controlling multi-page web applications, comprising the acts of:
providing a web application description to a central controller, the web application description having at least one statement to cause the display of a web page;
providing at least one web page description having at least one link that points to the central controller and that identifies the web application description;
the central controller, responding to an initial invokation thereof, causing statements in the web application to be executed;
before execution of the at least one statement that causes the display of a web page, causing implicit state information about the web application to be stored, including storing information identifying a statement to execute;
upon executing the at least one statement that causes the display of a web page, terminating execution of the web application description;
a user invoking the link in the web page thereby re-invoking the central contoller;
the central controller, responding to the re-invoking, by reading the stored implicit state information and beginning execution at the statement identified thereby.

2. The method of claim 1 wherein the web application description has at least two statements to cause the display of a web page and at least one explicitly defined state variable and wherein at least two web page descriptions are provided each having at least one link that points to the central controller and that identifies the web application description, and wherein before execution of a statement that causes the display of a web page, causing the explicitly defined state variable to be stored, and wherein upon executing any statement that causes the display of a web page, terminating execution of the web application description.

3. The method of claim 2 wherein the web application description includes statements to update the explicitly defined state variable in response to information provided by a user upon invoking a web page, and wherein the explicitly defined state variable is used by the web application description in causing the display of another web page.

4. A system for multi-page web applications, comprising:
a web application description stored at a web server, the web application description having at least one statement to cause the display of a web page;
at least one web page description stored on at least one web server the web page having at least one link that points to the central controller and that identifies the web application description;
a central controller having logic to read the web application description and to execute the statements thereof and having logic to store implicit state information about the web application before execution of any statement that causes the display of a web page, wherein the display of a web page terminates execution of the web application description, and having logic to restore implicit state information and begin execution at a next statement of the description as identified in the implicit state information.

5. The system of claim 4 wherein the web application description has at least two statements to cause the display of a web page and at least one explicitly defined state variable and wherein at least two web page descriptions are provided each having at least one link that points to the central controller and that identifies the web application description, and wherein the central controller includes logic to store the explicitly defined state variable before execution of a statement that causes the display of a web page and wherein upon executing any statement that causes the display of a web page execution of the web application description terminates.

6. The system of claim 5 wherein the web application description includes statements to update the explicitly defined state variable in response to information provided by a user upon invoking a web page, and wherein the explicitly defined state variable is used by the web application description in causing the display of another web page.
